(19) United States
(12) Patent Application Publication
(10) Pub. No.: US 2010/0180149 A1
(43) Pub. Date: Jul. 15, 2010

(54) METHOD AND DEVICE FOR STORING/READING DATA ON/FROM A RECORD MEDIUM AND FOR TRANSFERRING INFORMATION TO/FROM IT

(75) Inventors: Robert Albertus Brondijk, Eindhoven (NL); Josephus Joannes Mathijs Maria Geelen, Eindhoven (NL); Stephanus Josephus Maria Van Beckhoven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,728

(22) PCT Filed: Aug. 16, 2006
(86) PCT No.: PCT/IB06/52822

§ 371 Date: Feb. 13, 2008

(30) Foreign Application Priority Data
Aug. 17, 2005 (EP) 05300673.0

(51) Int. Cl. G06F 11/07; G06F 12/00

(52) U.S. Cl. 714/5; 711/154; 714/57; 711/E12.001; 714/E11.023; 714/E11.024; 714/E11.025

(57) ABSTRACT

A data storage system (1) comprises: an optical disc (2), preferably a CD, a DVD, or a BD, having a storage space (3) for data; a disc drive (10) suitable for writing/reading information to/from the disc (2); and a host device (20) capable of cooperating with the disc drive. The disc drive (10) is designed to receive (5) from the host device (20) a write command (WRITE(10); WRITE (12) {SB=0}; WRITE (12) {SB=I}) or a read command (READ(10); READ (12) {SB=0}; READ (12) {SB=1}). The disc drive is capable of operating in a normal mode and in at least one enhanced mode, the disc drive being responsive to a mode select command received from the host (20) to set its operative mode to a corresponding one of said modes; wherein, at least when an error occurs during writing, the medium access device acts differently in the enhanced mode as compared to the normal mode.

### FIELD OF THE INVENTION

The present invention relates in general to the field of storing data on a recordable medium. The present invention relates particularly to the field of optical storage, such as CD, DVD, BluRay, and the invention will be explained hereinafter for the case of BluRay, but it is to be noted that this is by way of example only and is not intended to restrict the scope of the invention. The gist of the present invention is also applicable to other types of record discs, either optical or not, and the gist of the present invention is even applicable to recordable media other than disc type.

### BACKGROUND OF THE INVENTION

Since the technology of optical data storage in general, including the way in which information can be stored in an optical disc, is commonly known, it is not necessary here to explain this technology in great detail. It is briefly summarized that an optical storage disc comprises at least one track, either in the form of a continuous spiral or in the form of multiple concentric circles, of storage space where information may be stored in the form of a data pattern. The storage space is divided into blocks. The data to be written is organized into data sectors, each sector comprising a user data portion and a header portion. A data sector is written into a storage block.

Optical discs may be read-only type. In that case, the information, which is put on the disc during the manufacturing process, can only be read by a user. However, the optical storage disc may also be a writable or recordable type, in which case information may be stored by a user; this information can then be retrieved later.

For writing information into the storage space of a writable optical storage disc, or for reading information from the storage space of a writable or read-only optical storage disc, the storage track is scanned by an optical beam, typically a laser beam. The actual handling of the storage disc is performed by an apparatus that will be indicated as disc drive apparatus. This handling includes the functions of receiving, holding, and rotating the disc. This handling also includes the functions of generating the laser beam(s); directing, focussing and displacing the laser beam(s); suitably modulating the laser beam(s) for writing; sensing the reflected beam(s) for reading. This handling also includes the functions of error correction, deciding which information to write at which physical addresses, etc.

The above-mentioned general functions of the disc drive apparatus are known per se. The present invention is not aiming at improving these general functions; in fact, the present invention may be implemented while using the general functions according to the state of the art. Therefore, a more detailed description and explanation of these general functions is omitted here. It suffices to say that the disc drive apparatus has a data input for receiving data-to-be-stored, and a data output for outputting data-read-from-disc.

Typically, apart from an optical disc as a record medium and a disc drive apparatus for handling the disc, an optical storage system comprises a host apparatus. The host apparatus, which may be a PC running a suitable program, or an application of a consumer apparatus such as a video recorder, is a device which communicates with the disc drive, sending commands to the disc drive instructing the disc drive what to do. In a reading mode, the host apparatus sends read commands to the disc drive, instructing the disc drive to read data from a certain storage location; in response, the disc drive reads data from the disc and transfers the data to the host apparatus. In a writing mode, the host apparatus transfers data to the disc drive, and sends write commands to the disc drive, instructing the disc drive to write the data to a certain storage location; in response, the disc drive writes the data received from the host.

Thus, for communication with the disc drive, the host apparatus has a data output for transferring data-to-be-stored, and a data input for receiving data-read-from-disc. Further, the host has a command output for sending command signals to the disc drive, and the disc drive has a command input for receiving command signals from the host. The command output may be separate from the data output, or it may be one combined output.

Basically, the disc drive can only do as instructed, i.e. just read or write. However, errors may occur in these operations. The disc drive may try to correct these errors, but this takes time and consequently reduces the information throughput rate. Depending on the “intentions” of the host, it may or may not be acceptable to reduce the information throughput rate. A problem is that the disc drive can not derive the host's intentions from the data: for the disc drive, all data are equal, namely a succession of bytes.

For instance, in case the data relates to a text document, it is important to have all data with as few errors as possible, even if the transfer process takes somewhat longer. On the other hand, in case the data relate to a video or audio recording, it is important that the data stream continues: an error may cause an artefact in the image, but a time consuming error correction process may result in a screen without image at all.

Thus, it is desirable for the host to be able to send instructions to the disc drive relating to the way in which the disc drive should deal with the data, especially in case of errors. Especially, depending on whether integrity of the data is important, or whether high throughput is important, it should be possible for the host to change the operational behaviour of the disc drive.

In principle, these problems could be solved by including corresponding instructions in the write or read commands, respectively. However, the formats of the write command and of the read command are fixed in corresponding standards, as will be clear to persons skilled in the art, and these formats have no room for additional instructions. Again, in principle, it is possible to redefine the formats of the write command and of the read command, but this would introduce the problem that the redefined format is not compatible with the existing format. An old host implementing the old format would be unable to cooperate with a new disc drive implementing the new format, and a new host implementing the new format would be unable to cooperate with an old disc drive implementing the old format.

Currently, the applicable standard defines two command structures for the read command, indicated as READ(10) and READ(12), respectively. Likewise, the applicable standard defines two command structures for the write command, indicated as WRITE(10) and WRITE(12), respectively. With respect to the READ(10)/WRITE(10) commands, the READ(12)/WRITE(12) commands contain more bits, in order to be able to address disc drives having a larger data storage capacity. These READ(12)/WRITE(12) commands do include one bit that is available to the host for changing the disc drive's operational quality: this is the so-called “streaming bit”, hereinafter indicates as SB. The READ(10)/WRITE(10) commands do not have such bit.

According to the current standard, this bit SB is used to set the level of integrity for the disc drive. If this bit is set (SB=1), indicating that the host is operating in a streaming mode (such as video) and therefore is expecting a continuous data stream, the disc drive (in a reading mode) will deliver to the host the data read from disc, regardless of its integrity (i.e. the possible occurrence of errors), and the disc drive will not even inform the host whether or not errors have occurred. This may be fine for CD, in which case the host is capable of determining, from examining the received data, whether or not the data is corrupt, and error correction codes are available; however, in the case of DVD, BD, HD, this is not possible for the host. Thus, it is further desirable that the host be informed of possible corrupted data.

If, in contrast, said bit is not set (SB=0), indicating that the host is operating in a mode where it expects the highest level of data handling integrity from the disc drive, the disc drive (in a reading mode) may consume time by retrying to read data from bad blocks or by jumping to and from replacement locations. Thus, using the commands currently available, the host can only choose between a data processing mode with high throughput and low (at least unspecified) integrity (SB=1) and a data processing mode with low throughput and high integrity (SB=0). This applies only to hosts capable of using the READ(12)/WRITE(12) commands; in the case of hosts which are only capable of using the READ(10)/WRITE(10) commands, the resulting disc drive operation corresponds to the case SB=0 for READ (12)/WRITE (12) commands.

Accordingly, an important objective of the present invention is to overcome the above problems.

### SUMMARY OF THE INVENTION

According to an important aspect of the present invention, a disc drive is capable of operating in an enhanced mode, and is responsive to a host command for switching between operating in the enhanced mode and operating in a normal mode. The host command is advantageously a mode selection command incorporated in a Mode Page Command, which is a command of which the format is proposed by the National Committee for Information Technology Standards (NCITS): Working Draft, T10/1363-D, Revision 10g, Nov. 12, 2001, “INFORMATION TECHNOLOGY—SCSI Multimedia Commands”—(revision MMC10g, hereinafter briefly indicated as MMC-3).

The mode selection command may correspond to one bit in the Mode Page Command. Hosts which do not implement the present invention will set this bit to value zero; a disc drive implemented in accordance with the present invention will interpret this as indicating a command for operating in the normal mode. In the normal mode, the disc drive will operate as described above, like prior-art disc drives. A disc drive which does not implement the present invention will ignore the mode selection command bit, and will operate as before, in what we now call “normal mode”.

A host implementing the present invention may set the mode selection command bit to 1; a disc drive implementing the present invention will interpret this as indicating a command for operating in the enhanced mode. In the enhanced mode, the disc drive responds differently to READ (10)/WRITE (10) commands, READ(12)/WRITE(12) commands with SB=0, and READ(12)/WRITE(12) commands with SB=1, as compared to normal mode. In any case, an error message will be sent to the host.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram schematically illustrating a data storage system;

FIGS. 2A and 2B are tables illustrating command descriptor blocks of read commands;

FIGS. 3A and 3B are tables illustrating command descriptor blocks of write commands;

FIGS. 4A and 4B are tables illustrating a command descriptor block of a mode page command;

FIGS. 5 and 6A-G are flow diagrams illustrating the operation of a disc drive in accordance with the present invention.

### DETAILED DESCRIPTION OF THE INVENTION

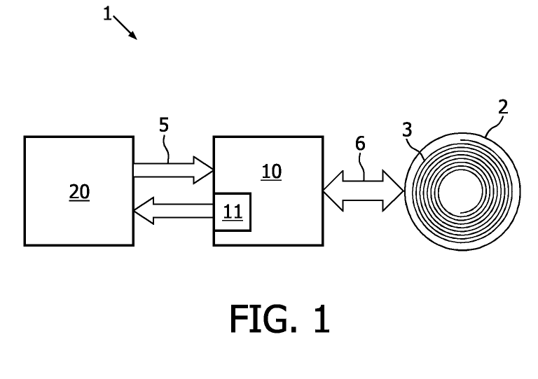

FIG. 1 is a block diagram schematically illustrating a data storage system 1, comprising a data storage medium 2, a medium access device 10, and a host device 20. In a typical practical implementation, the host device 20 may be a suitably programmed personal computer (PC); it is also possible that the data storage system 1 is implemented as a dedicated user apparatus such as a video recorder, in which case the host device 20 is the application part of such apparatus. In a specific embodiment, the data storage medium 2 is implemented as an optical disc, for instance a DVD or a BD, in which case the medium access device 10 is implemented as a disc drive. In the following, the invention will be described specifically for an optical disc implementation, but it is noted that the present invention is not limited to optical discs.

The optical disc 2 has a storage space 3, which has the form of one or more continuous spiral-shaped tracks or one or more tracks in the form of multiple concentric circles, where information can be stored in the form of a data pattern. Since this technology is commonly known to persons skilled in the art, this technology will not be explained in further detail.

In FIG. 1, a host/drive communication link between host device 20 and disc drive 10 is indicated at 5. Likewise, a drive/disc communication link between disc drive 10 and disc 2 is indicated at 6. The drive/disc communication link 6 represents the physical (optical) read/write operation as well as the physical addressing of blocks of the storage space 3. The host/drive communication link 5 represents a data transfer path as well as a command transfer path.

When the host device 20 wants to access a certain piece of information on the disc 2, it sends a command to the disc drive 10, indicating the logical address on disc where the information is to be found. In response, the disc drive 10 starts reading the information starting at the said logical address, and transfers the data read to the host over the link 5. Since the process of data transfer from disc drive to host is known per se, it is not necessary here to explain such process in greater detail.

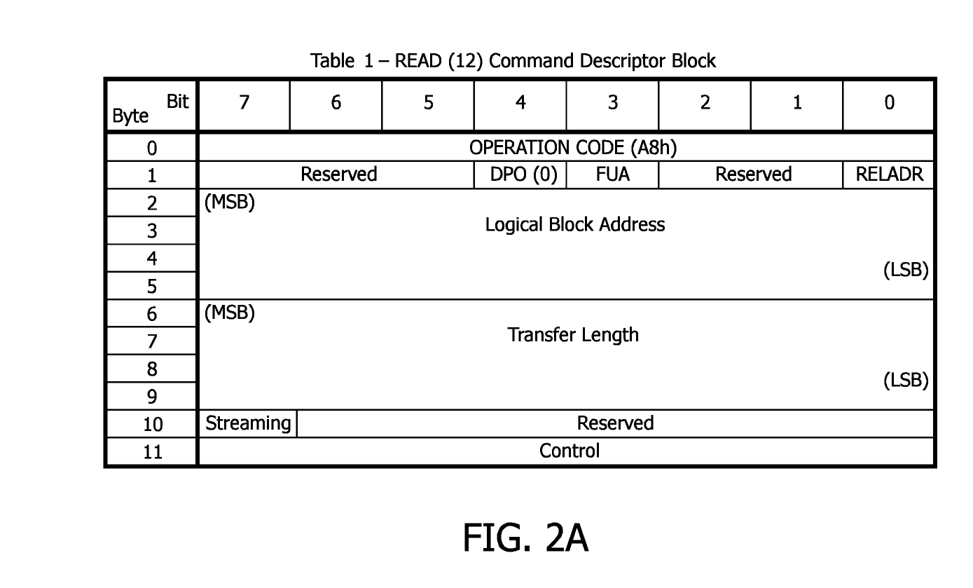

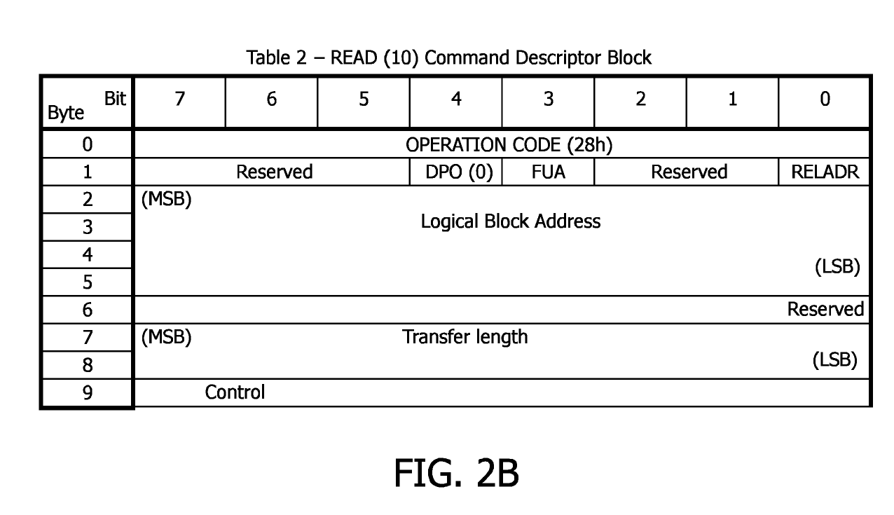

FIG. 2A is a table illustrating a READ(12) command descriptor block. As illustrated by the table 1 in FIG. 2A, the READ(12) command comprises 12 bytes of 8 bits each. Byte 0 contains an operation code, bytes 2-5 are used to indicate the logical block address of the storage space where the data should be read, and bytes 6-9 are used to indicate the length of the data sector to be transferred. Byte 11 is a control byte. Bit 7 of byte 10 is the streaming bit discussed above.

Bits 1, 2 and 5-7 of byte 1, and bytes 0-6 of byte 10 are reserved for later definition, i.e. they do not have a defined meaning yet. So, it is possible to use any one of these bits as a mode command bit.

A READ(10) command is similar to the READ(12) command, but has only 10 bytes, reducing the maximum block address that can be addressed by this command.

FIG. 2B is a table illustrating a READ(10) command descriptor block. As illustrated by the table 2 in FIG. 2B, the READ(10) command comprises 10 bytes of 8 bits each. Byte 0 contains an operation code, bytes 2-5 are used to indicate the logical block address of the storage space where the data should be read, and bytes 7-8 are used to indicate the length of the data sector to be transferred. Byte 9 is a control byte.

Bits 1, 2 and 5-7 of byte 1, and bytes 0-7 of byte 6 are reserved for later definition, i.e. they do not have a defined meaning yet. So, it is possible to use any one of these bits as a mode command bit.

When the host device 20 wants to write a certain piece of information to the disc 2, it sends a command to the disc drive 10, indicating the logical address on disc where the information is to be written, and also transfers the data to be written to the disc drive 10 over the link 5. In response, the disc drive 10 starts writing the information received, starting at the said logical address. Since the process of data transfer from host to disc drive is known per se, it is not necessary here to explain such process in greater detail.

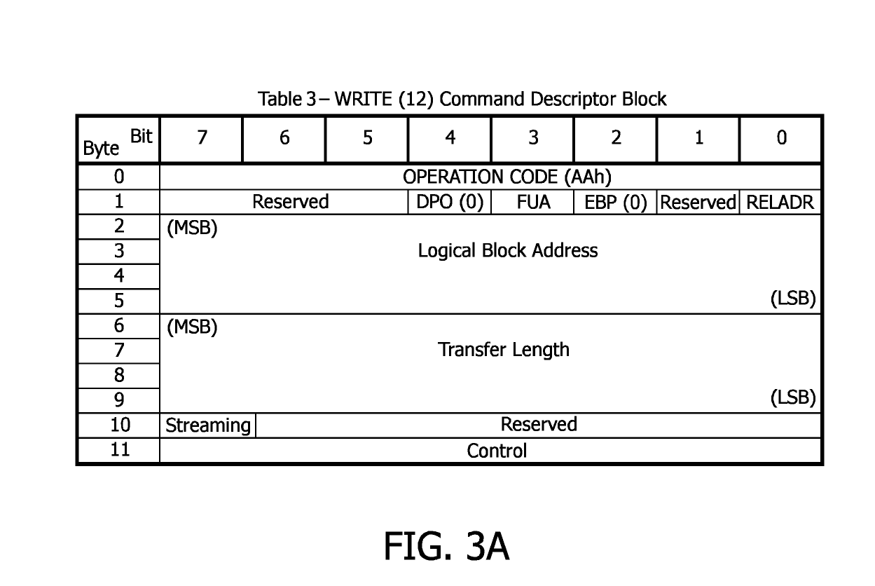

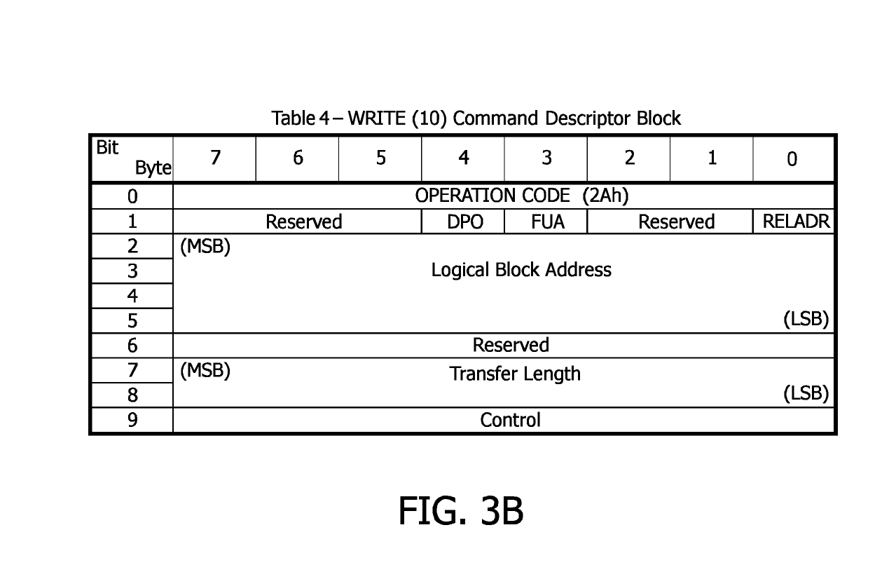

FIG. 3A is a table illustrating a WRITE(12) command descriptor block. As illustrated by the table 3 in FIG. 3A, the WRITE(12) command comprises 12 bytes of 8 bits each. Byte 0 contains an operation code, bytes 2-5 are used to indicate the logical block address of the storage space where the data should be stored, and bytes 6-9 are used to indicate the length of the data sector to be transferred. Byte 11 is a control byte. Bit 7 of byte 10 is the streaming bit discussed above.

Bits 1, 5-7 of byte 1, and bytes 0-6 of byte 10 are reserved for later definition, i.e. they do not have a defined meaning yet. So, it is possible to use any one of these bits as a mode command bit.

A WRITE(10) command is similar to the WRITE(12) command, but has only 10 bytes, reducing the maximum block address that can be addressed by this command.

FIG. 3B is a table illustrating a WRITE(10) command descriptor block. As illustrated by the table 4 in FIG. 3B, the WRITE(10) command comprises 10 bytes of 8 bits each. Byte 0 contains an operation code, bytes 2-5 are used to indicate the logical block address of the storage space where the data should be stored, and bytes 7-8 are used to indicate the length of the data sector to be transferred. Byte 9 is a control byte.

Bits 1, 2, 5-7 of byte 1, and bytes 0-7 of byte 6 are reserved for later definition, i.e. they do not have a defined meaning yet. So, it is possible to use any one of these bits as a mode command bit.

Using one of the bits of the READ or WRITE commands as a mode command bit implies that the parameters of the READ or WRITE commands, respectively, should be modified for each command, and apply only to the specific command. This may in practice be inconvenient. According to the invention, it is preferred to set the drive in an operative mode that applies to all applications accessing the drive without the necessity that such applications be modified. Therefore, according to a preferred embodiment of the present invention, a bit of a MODE PAGE command is used as a mode command bit.

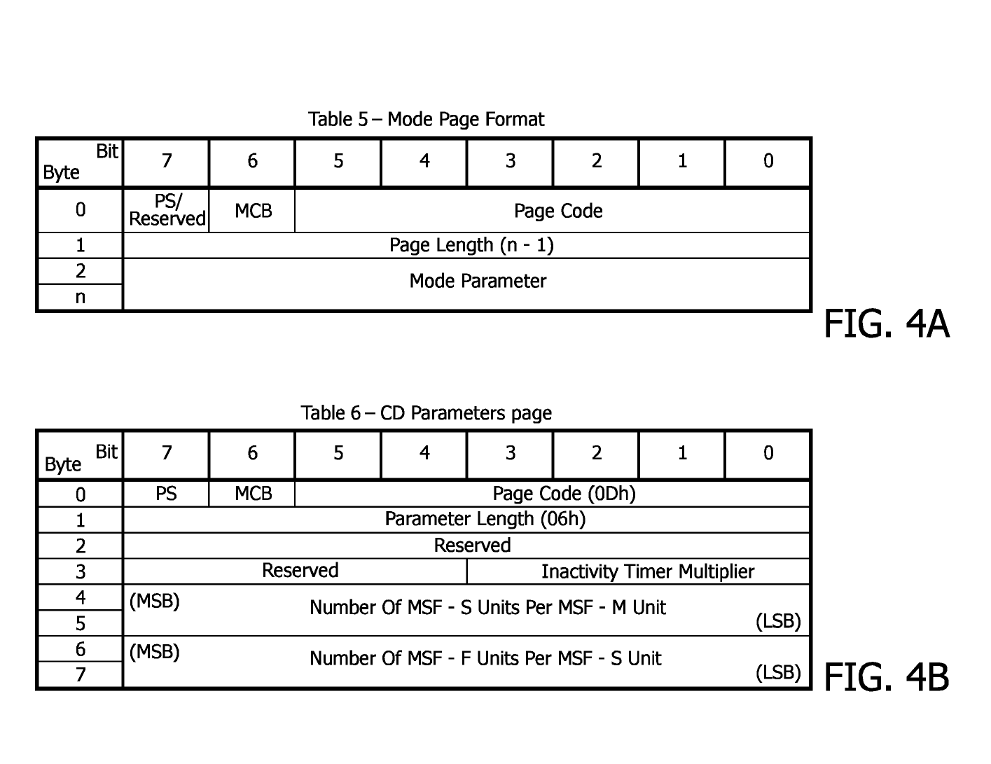

FIG. 4A is a table illustrating a MODE PAGE command descriptor block in general; FIG. 4B is a table illustrating a MODE PAGE command descriptor block specifically for CD. As illustrated by the table in FIG. 4A, the size of the MODE PAGE command is not fixed; the size is defined in byte 1. Bits 0-5 of byte 0 contain a page code, which is 0Dh in the example of FIG. 4B. In that same example, byte 2 and bits 4-7 of byte 3 are reserved for later definition, i.e. they do not have a defined meaning yet. The same applies in general for bit 6 of byte 0. So, it is possible to use any one of these bits as a mode command bit. In the preferred embodiment of the present invention, bit 6 of byte 0 is used as mode command bit, which will hereinafter be indicated as MCB.

The value MCB=0 means “normal mode”, which is compatible with current hosts 20 and current disc drives 10. Current hosts, and hosts which do not implement the present invention, will not set this bit, so this bit will have the default value zero. Disc drives implementing the present invention will read the value of MCB, and are responsive to the value MCB=0 by setting the operative mode to “normal mode”, or maintaining this mode. Current disc drives, and disc drives which do not implement the present invention, will ignore MCB, and will operate as in prior art, i.e. in “normal mode”.

A host implementing the present invention may either send a MODE PAGE command with MCB=0, thus effectively sending a mode command for “normal mode”, or may send a MODE PAGE command with MCB=1, thus effectively sending a mode command for “enhanced mode”, depending on the type of quality service the host is expecting from the disc drive. Sending a MODE PAGE command with MCB=1 will have no effect in case the disc drive is a current disc drive, or anyway a disc drive which does not implement the present invention. Disc drives implementing the present invention will read the value of MCB, and are responsive to the value MCB=1 by setting the operative mode to “enhanced mode”, or maintaining this mode.

As long as a disc drive does not receive a MODE command, it will maintain the operative mode as set by the last MODE command, until receiving a next MODE command. After power on or reset, the disc drive will start in the normal mode.

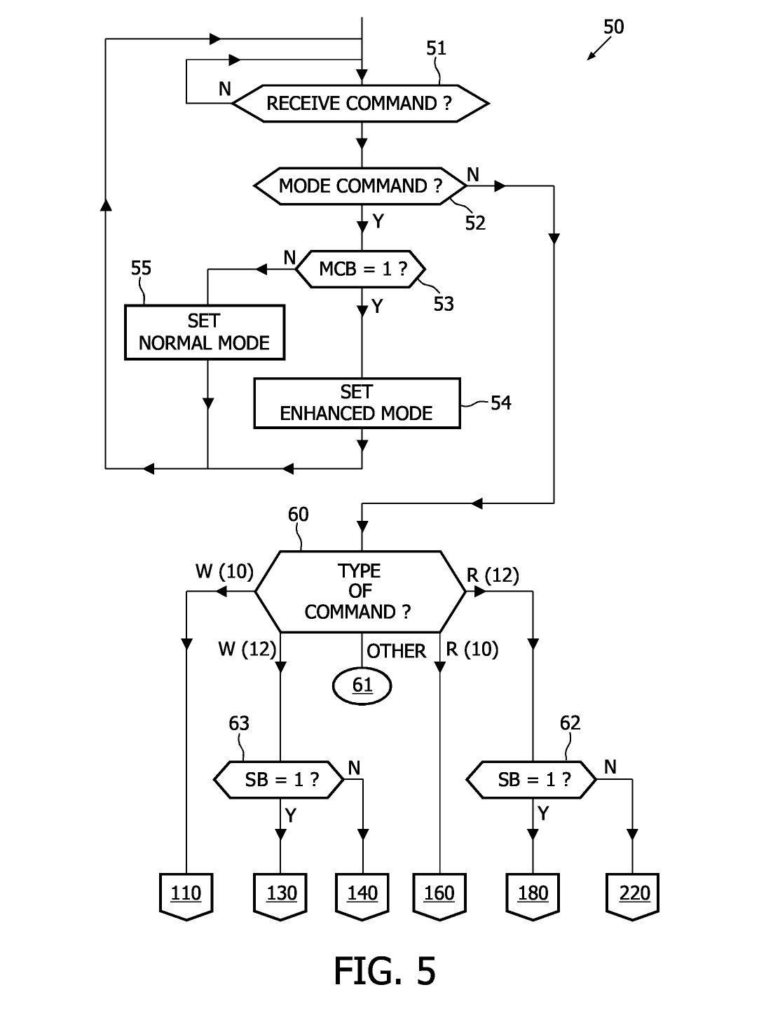

FIG. 5 is a flow diagram schematically illustrating an embodiment of the operation 50 of a disc drive 10 implementing the present invention. This embodiment is selected to clarify the difference between “normal mode” and “enhanced mode” as clearly as possible.

In step 51, the disc drive 10 checks whether it receives a command from the host. If so, the disc drive 10 checks in step 52 whether the command is a MODE command. If so, the disc drive 10 checks in step 53 whether MCB=1. If so, the disc drive 10 sets its operative mode to “enhanced mode” (by setting a flag in a memory location, or the like, as will be clear to a person skilled in the art) [step 54], otherwise the disc drive 10 sets its operative mode to “normal mode” [step 55]. Then, the disc drive 10 returns to step 51 to await further commands.

If in step 52 it appears that the command received is not a MODE command, the disc drive 10 checks in step 60 whether the command is a READ command, a WRITE command, or some other command which is not relevant for the present invention; in the latter case, the disc drive 10 continues with performing the commanded task in step 61.

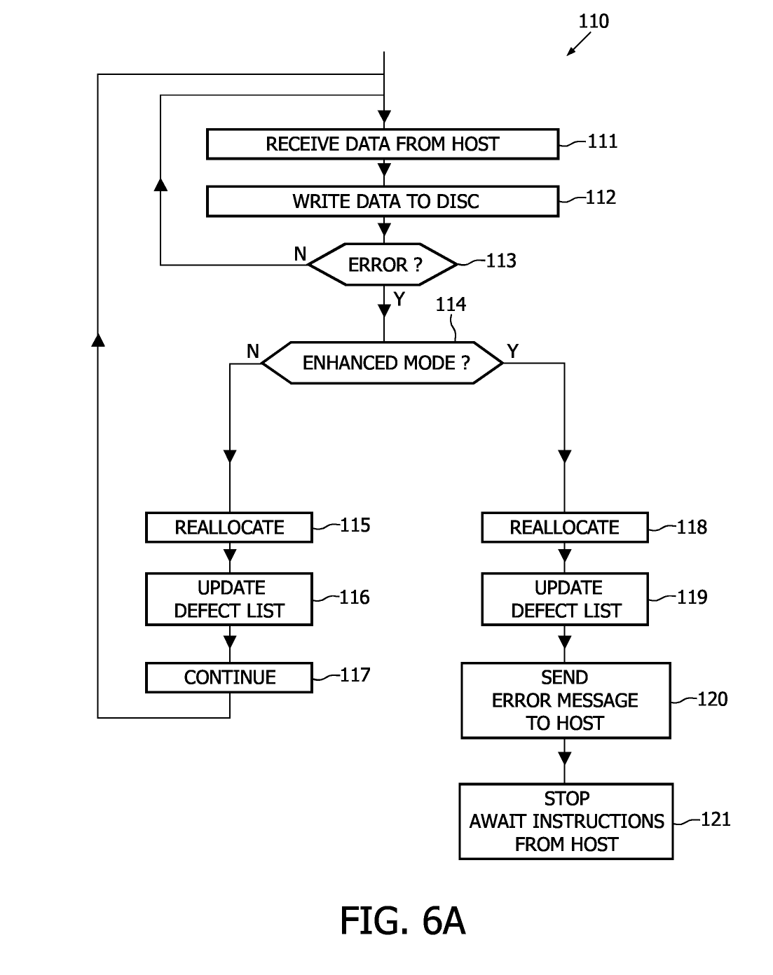

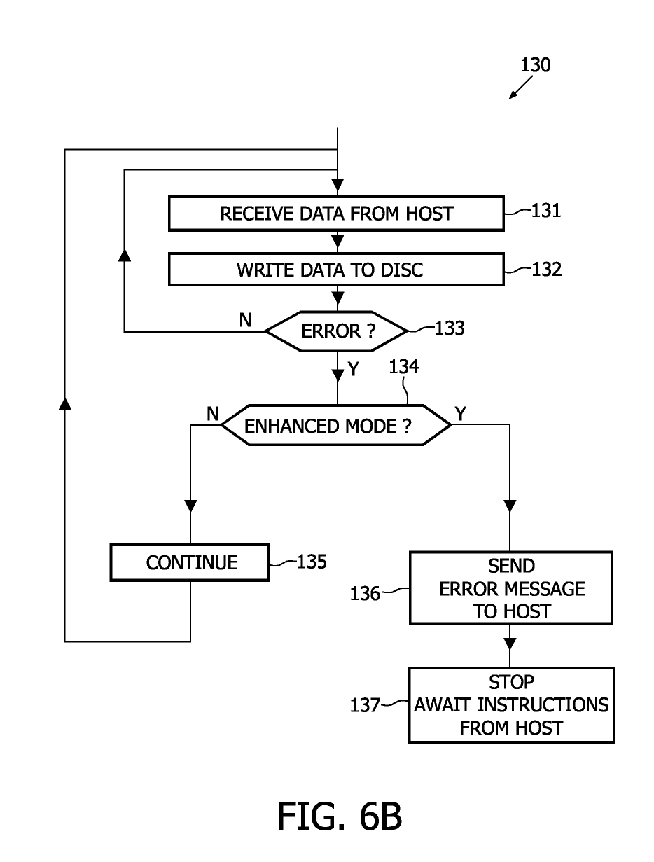

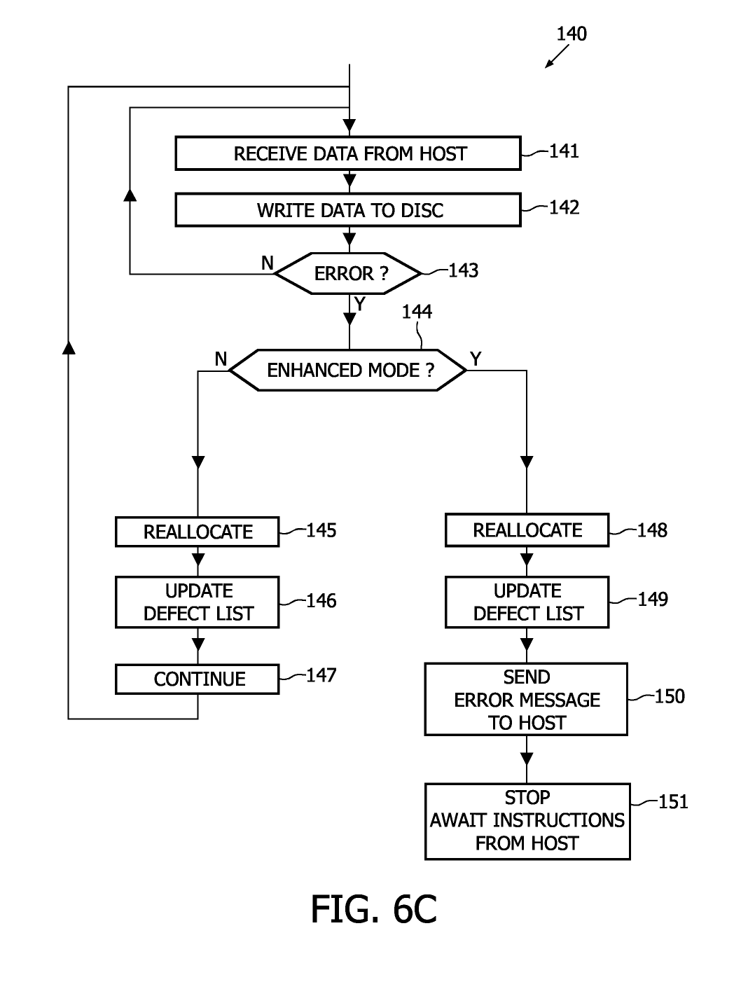

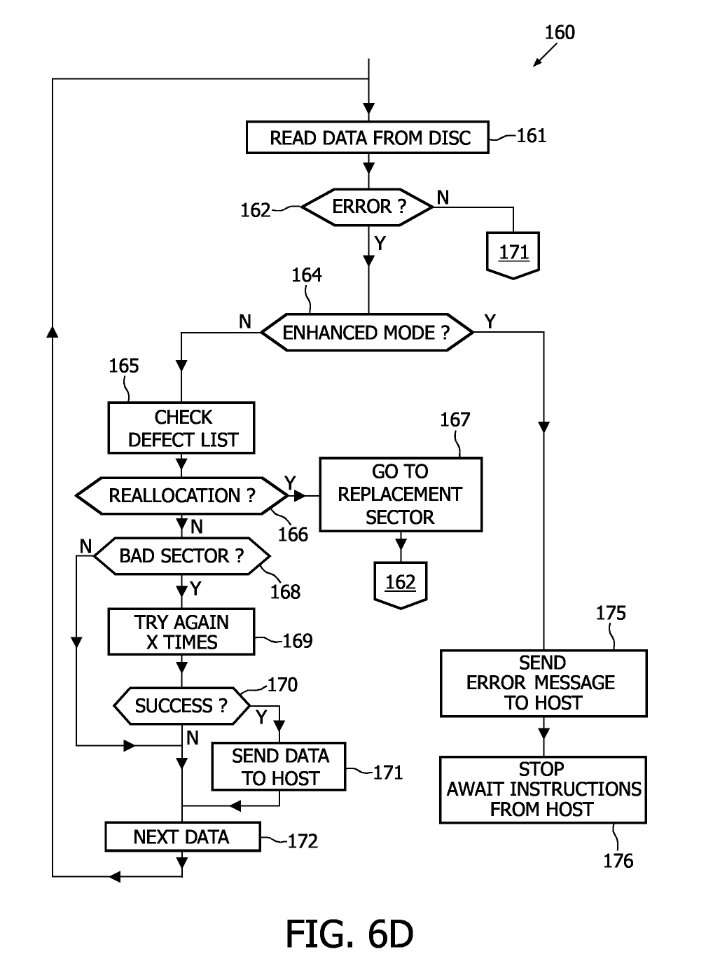

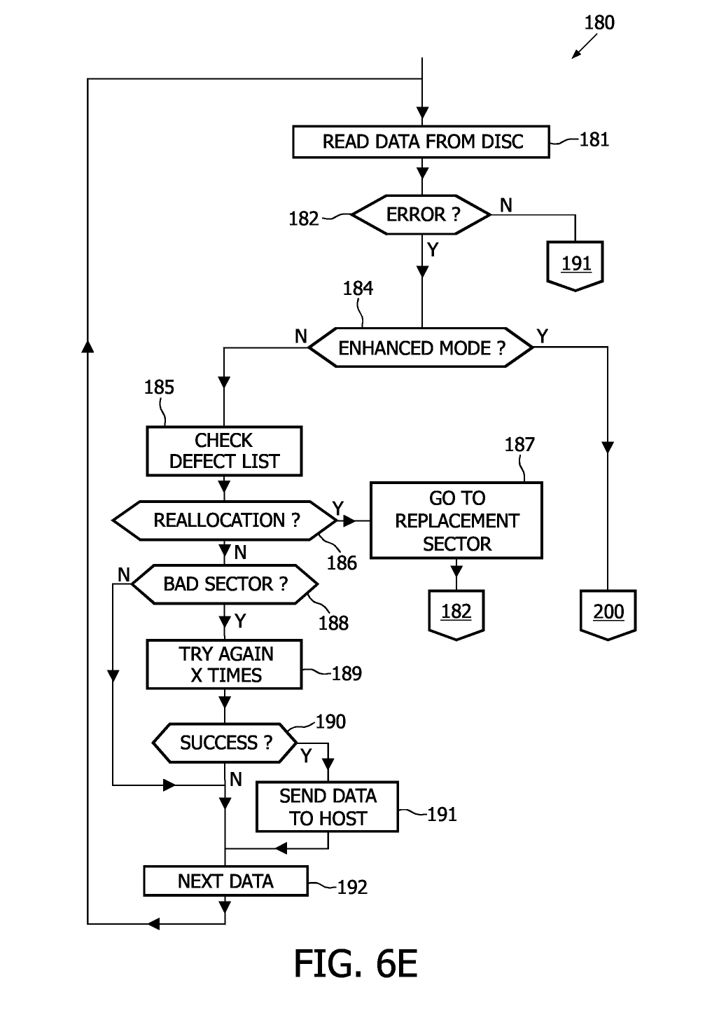

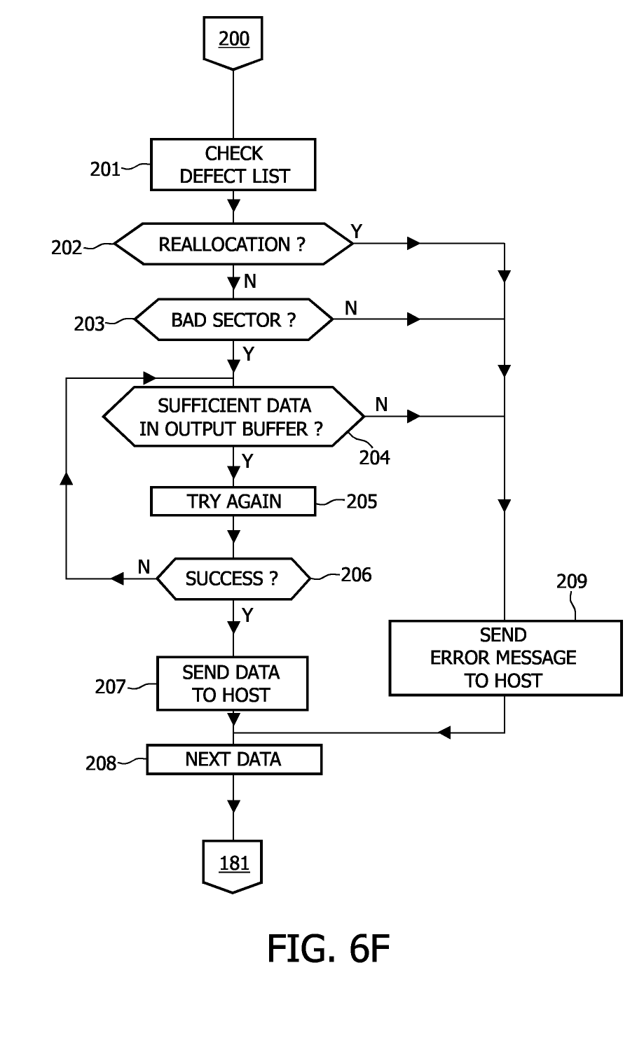

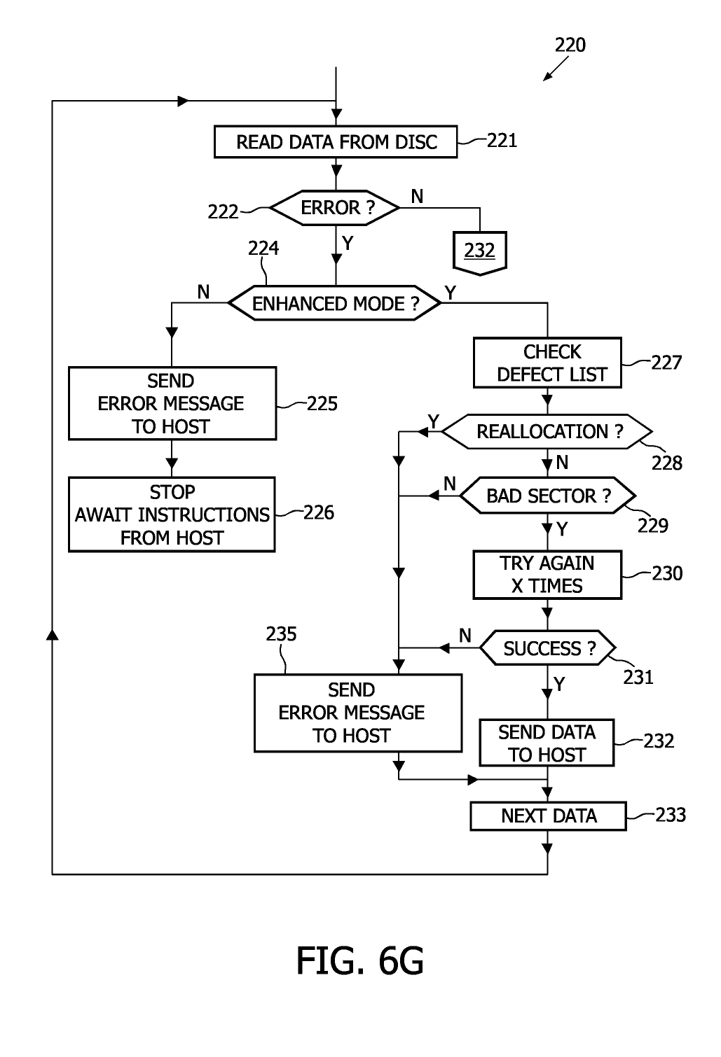

If in step 60 it appears that the command received is a READ(12) command, the disc drive 10 checks in step 62 the value of SB. Likewise, if in step 60 it appears that the command received is a WRITE(12) command, the disc drive 10 checks in step 63 the value of SB. So, there are six different situations possible: the command received is a READ(10) command, a WRITE(10) command, a READ(12){SB=0} command, a WRITE(12){SB=0} command, a READ(12){SB=1} command, a WRITE(12){SB=1} command. For each of these situations, the operation of the disc drive 10 will be described separately (operations 110, 130, 140, 160, 180, 220), with reference to FIGS. 6A-G.

If the command is a WRITE(10) command, the disc drive performs operation 110, illustrated in FIG. 6A. The disc drive receives data from the host [step 111] and writes these data to disc [step 112]. In step 113, the disc drive checks whether an error has occurred; if not, the disc drive continues with step 111.

If an error has occurred, the disc drive determines whether it is operating in normal mode or in enhanced mode [step 114]. In normal mode, the disc drive tries to reallocate the data to a spare sector [step 115], updates the defect list [step 116], and continues [step 117] with receiving data from the host [step 111].

If the disc drive is operating in enhanced mode, the disc drive tries to reallocate the data to a spare sector [step 118] and to update the defect list [step 119], comparable to steps 115 and 116 in normal mode. Then, deviating from the normal mode, the disc drive sends an error message to the host [step 120], and stops the writing process to await instructions from the host [step 121]. In a variation, step 115 and 118 can be combined into one step that is executed before step 114. The same applies to steps 116 and 119.

If the command is a WRITE(12){SB=1} command, the disc drive executes the operation 130, illustrated in FIG. 6B. Steps 131 to 134 are identical to steps 111 to 114, respectively, of operation 110. If an error is found and the disc drive is operating in normal mode, the disc drive continues [step 135] to step 131, similar to step 117 of operation 110, skipping the steps 115 and 116 of operation 110. If an error occurs and the disc drive is operating in enhanced mode, the disc drive sends an error message to the host [step 136] and stop to await instructions from the host [step 137], similar to steps 120 and 121 of operation 110, thus skipping steps 118 and 119 of operation 110.

If the command is a WRITE(12){SB=0} command, the disc drive executes operation 140, illustrated in FIG. 6C. Steps 141 to 151 of operation 140 are identical to steps 111 to 121, respectively, of operation 110, so it is not necessary to explain these steps again. It is noted that, basically, operation 140 is identical to operation 110.

If the command is a READ(10) command, the disc drive executes operation 160, illustrated in FIG. 6D. In step 161, the disc drive reads data from disc, and in step 162 the disc drive checks whether an error has occurred. If no error occurs, the disc drive sends the data to the host [step 171], and continues with reading next data [step 172].

If it is found that the data contains an error, the disc drive determines whether it is operating in normal mode or in enhanced mode [step 164]. If the disc drive is operating in normal mode, it will consult the defect list [step 165] to determine whether the data has been reallocated to a replacement sector [step 166]; if so, the disc drive jumps to the replacement sector [step 167] and continues at step 162. If no reallocation has taken place, the disc drive investigates in step 168 whether the error is due to a bad sector. If so, the disc drive may try to read this sector again for a number of times [step 169], and if this is successful [step 170], the disc drive will send the data to the host [step 171]. If the retry does not bring any success, or if the error is not due to a bad sector, the disc drive ignores the error and continues with reading next data [step 172].

If an error occurs while the disc drive is operating in enhanced mode, the disc drive will send an error message to the host [175] and stops reading the data to await instructions from the host [step 176].

If the command is a READ(12){SB=1} command, the disc drive executes operation 180, illustrated in FIGS. 6E and 6F. Steps 181 to 192 are identical to steps 161 to 172 of operation 160, so it is not necessary to explain these steps again. It is just noted that the effect of the READ (12) {SB=1} command is identical to the effect of the READ (10) command when the disc drive is operating in normal mode.

When the disc drive is operating in enhanced mode, the disc drive continues [step 200] to consult the defect list [step 201] to see whether the data has been reallocated to a replacement sector; if so, the disc drive ignores the replacement sector, and just sends an error message to the host [step 209], and then is ready to read next data [step 208] by jumping back to step 181.

If in step 202 it appears that the data has not been reallocated, the disc drive determines in step 203 whether the error is due to a bad sector; if not, the disc drive continues at step 209 as described above.

If the error is due to a bad sector, it may be possible to obtain the data by retrying, but, in order to avoid a situation where the data flow to the host is interrupted, the disc drive checks first whether there is sufficient data in its output buffer 11 [step 204] indicating that the host can receive data for some time without the disc drive needing to immediately provide new data. If the amount of data in the output buffer 11 is insufficient, the disc drive continues with step 209 as described above. In contrast, if there is sufficient data in the output buffer 11, the disc drive will try to read the data again [step 205] and determines in step 206 whether the retry has been successful. If not, the disc drive can retry again by jumping back to step 204. If the retry was successful, the disc drive sends the data to the host [step 207], and is ready to receive next data [step 208] by jumping back to step 181.

If the command is a READ(12){SB=0} command, the disc drive executes operation 220, illustrated in FIG. 6G. Steps 221 to 224 of operation 220 are identical to steps 161 to 164 of operation 160, so it is not necessary to explain these steps again. If the disc drive is operating in normal mode, the disc drive sends an error message to the host [step 225], and stops reading to await instruction from the host [step 226]. This corresponds to the enhanced mode in the case of a READ(10) command (steps 175-176).

If the disc drive is operating in enhanced mode, it will consult the defect list [step 227] to find whether the data has been reallocated to a replacement sector. If so, the disc drive ignores the replacement sector, and just sends an error message to the host [step 235] and is ready to read next data [step 233] by jumping back to step 221.

If in step 228 it appears that the data has not been reallocated, the disc drive determines in step 229 whether the errors in the data are due to a bad sector. If not, the disc drive continues at step 235 as described above, but if the error is due to a bad sector, the disc drive may try to obtain the requested data by reading the bad sector again for a number of times [step 230], giving it its best effort. The number of times (x) that the disc drive tries to read the bad sector again may be fixed or may vary depending on circumstances. It should be clear that, for higher x, the chances on successfully reading the data are higher, but the payoff is that the reading process takes longer.

If a retry is successful [step 231], the disc drive will send the data to the host [step 232], and is then ready to read next data [step 233] by returning to step 221. Otherwise, after trying for a number of times, the disc drive gives up [step 231] and continues with step 235 as described above.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Medium access device (10), suitable for writing information to a storage medium (2) which has a storage space (3) for receiving data, the medium access device (10) being designed to receive (5) from a host device (20) a write command (WRITE(10); WRITE(12){SB=0}; WRITE(12){SB=1}) and data to be written to the storage medium (2);
the medium access device being capable of operating in a normal mode and in at least one enhanced mode, the medium access device being responsive to a mode select command received from the host device (20) to set its operative mode to a corresponding one of said modes;
wherein, at least when an error occurs during writing, the medium access device acts differently in the enhanced mode as compared to the normal mode.

2. Medium access device according to claim 1, wherein the mode select command is contained in the MODE PAGE command.

3. Medium access device according to claim 2, wherein the mode select command is contained in bit 6 of byte 0 of the MODE PAGE command.

4. Medium access device according to claim 1, wherein, in case during writing an error occurs, the medium access device, when operating in the enhanced mode, is designed to always send an error message to the host.

5. Medium access device according to claim 4, wherein the medium access device is designed, after having sent the error message to the host, to stop the writing process and await further instructions from the host device.

6. Medium access device according to claim 1, wherein the medium access device, when operating in the enhanced mode, in response to receiving a WRITE(10) command, is designed to write the received (step 111) data to the medium (step 112) and to check (step 113) for the occurrence of writing errors, and, if it finds that a writing error has occurred, to reallocate the data to a replacement location (step 118), to update a defect list (step 119), and then to send an error message to the host (step 120).

7. Medium access device according to claim 1, wherein the medium access device, when operating in the enhanced mode, in response to receiving a WRITE(12){SB=1} command, is designed to write the received (step 131) data to the medium (step 132) and to check (step 133) for the occurrence of writing errors, and, if it finds that a writing error has occurred, to send an error message to the host (step 136).

8. Medium access device according to claim 1, wherein the medium access device, when operating in the enhanced mode, in response to receiving a WRITE(12){SB=0} command, is designed to write the received (step 141) data to the medium (step 142) and to check for the occurrence of writing errors (step 143), and, if it finds that a writing error has occurred, to reallocate the data to a replacement location (step 148), to update a defect list (step 149), and then to send an error message to the host (step 150).

9. Host device (20), capable of cooperating with a medium access device (10) according to claim 1;
the host device (20) being designed to send (5) to said medium access device (10) a mode select command for setting the enhanced mode of the medium access device (10).

10. Host device according to claim 9, designed to send (5) to said medium access device (10) a MODE PAGE command wherein bit 6 of byte 0 of the MODE PAGE command is set to 1.

11. Medium access device (10), suitable for reading information from a storage medium (2) which has a storage space (3) for containing data, the medium access device (10) being designed to receive (5) from a host device (20) a read command (READ(10); READ(12){SB=0}; READ(12){SB=1}) and to send data read from the medium to the host;
the medium access device being capable of operating in a normal mode and in at least one enhanced mode, the medium access device being responsive to a mode select command received from the host device (20) to set its operative mode to a corresponding one of said modes;
wherein, at least when an error occurs during reading, the medium access device acts differently in the enhanced mode as compared to the normal mode.

12. Medium access device according to claim 11, wherein the mode select command is contained in the MODE PAGE command.

13. Medium access device according to claim 12, wherein the mode select command is contained in bit 6 of byte 0 of the MODE PAGE command.

14. Medium access device according to claim 11, wherein, in case during reading an error occurs that can not be rectified, the medium access device, when operating in the enhanced mode, is designed to always send an error message to the host.

15. Medium access device according to claim 11, wherein the medium access device, when operating in the enhanced mode, in response to receiving a READ(10) command, is designed to read (step 161) data from the medium and to check (step 162) for the occurrence of reading errors, and, if it finds that a reading error has occurred, to send an error message to the host (step 175).

16. Medium access device according to claim 15, wherein the medium access device is designed, after having sent the error message to the host, to stop the reading process and await further instructions from the host device (step 176).

17. Medium access device according to claim 11, wherein the medium access device, when operating in the enhanced mode, in response to receiving a READ(12){SB=1} command, is designed to read (step 181) data from the medium and to check (step 182) for the occurrence of reading errors, and, if it finds that a reading error has occurred, to check whether the data of the sector being addressed has been reallocated to a replacement sector (steps 201, 202), and if so, to send an error message to the host (step 209) and then continue the reading process (step 181) as from the next non-reallocated sector.

18. Medium access device according to claim 11, comprising an output buffer (11), wherein the medium access device, when operating in the enhanced mode, in response to receiving a READ(12){SB=1} command, is designed to read (step 181) data from the medium and to check (step 182) for the occurrence of reading errors, and, if it finds that a reading error has occurred, to check (step 203) whether the reading error is due to a bad sector, and if so, to determine (step 204) the amount of data in its output buffer (11).

19. Medium access device according to claim 18, wherein the medium access device, if there is sufficient data in its output buffer (11), is designed to try to re-read the data from said sector (step 205), or else, if there is not sufficient data in its output buffer (11), to send an error message to the host (step 209) and then continue the reading process (step 181).

20. Medium access device according to claim 19, wherein the medium access device, if the retry is successful (step 206), is designed to send (step 207) the data to the host and then continue the reading process (step 181).

21. Medium access device according to claim 11, wherein the medium access device, when operating in the enhanced mode, in response to receiving a READ(12){SB=0} command, is designed to read (step 221) data from the medium and to check (step 222) for the occurrence of reading errors, and, if it finds that a reading error has occurred, to check whether the data of the sector being addressed has been reallocated to a replacement sector (steps 227, 228), and if so, to send an error message to the host (step 235) and then continue the reading process (step 221) as from the next non-reallocated sector.

22. Medium access device according to claim 11, wherein the medium access device, when operating in the enhanced mode, in response to receiving a READ(12){SB=0} command, is designed to read (step 221) data from the medium and to check (step 222) for the occurrence of reading errors, and, if it finds that a reading error has occurred, to check (step 229) whether the reading error is due to a bad sector, and if so, to try to re-read the data from said sector (step 230) for a predetermined number (X) of times.

23. Medium access device according to claim 22, wherein the medium access device, if the retry is successful (step 231), is designed to send (step 232) the data to the host and then continue the reading process (step 221), or else, if the retry is not successful, to send an error message to the host (step 235) and then continue the reading process (step 221).

24. Host device (20), capable of cooperating with a medium access device (10) according to claim 11;
the host device (20) being designed to send (5) to said medium access device (10) a mode select command for setting the enhanced mode of the medium access device (10).

25. Host device according to claim 24, designed to send (5) to said medium access device (10) a MODE PAGE command wherein bit 6 of byte 0 of the MODE PAGE command is set to 1.

26. Data storage system (1), comprising:
a storage medium (2) having a storage space (3) for receiving data;
a medium access device (10), suitable for writing information to a storage medium (2) which has a storage space (3) for receiving data, the medium access device (10) being designed to receive (5) from a host device (20) a write command (WRITE(10); WRITE(12){SB=0}; WRITE(12){SB=1}) and data to be written to the storage medium (2);
the medium access device being capable of operating in a normal mode and in at least one enhanced mode, the medium access device being responsive to a mode select command received from the host device (20) to set its operative mode to a corresponding one of said modes;
wherein, at least when an error occurs during writing, the medium access device acts differently in the enhanced mode as compared to the normal mode; and
a host device (20) in accordance with claim 9.

27. Data storage system (1), comprising:
a storage medium (2) having a storage space (3) for receiving data;
a medium access device (10), suitable for reading information from a storage medium (2) which has a storage space (3) for containing data, the medium access device (10) being designed to receive (5) from a host device (20) a read command (READ(10); READ(12){SB=0}; READ(12){SB=1}) and to send data read from the medium to the host;
the medium access device being capable of operating in a normal mode and in at least one enhanced mode, the medium access device being responsive to a mode select command received from the host device (20) to set its operative mode to a corresponding one of said modes;
wherein, at least when an error occurs during reading, the medium access device acts differently in the enhanced mode as compared to the normal mode; and
a host device (20) in accordance with claim 24.

28. Data storage system according to claim 26, wherein said storage medium is an optical disc, preferably a CD, a DVD, or a BD, and wherein said medium access device is a disc drive.
